(19) United States
(12) Patent Application Publication
(10) Pub. No.: US 2009/0158343 A1
(43) Pub. Date: Jun. 18, 2009

(54) RECORDING DEVICE OF BROADCASTING PROGRAM

(75) Inventors: Masashi URUSHIHARA, Kawasaki (JP); Takashi Terasaki, Kawasaki (JP); Kunihiko Chikaue, Kawasaki (JP); Hiroshi Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/328,028

(22) Filed: Dec. 4, 2008

(30) Foreign Application Priority Data
Dec. 7, 2007 (JP) 2007-317118

(51) Int. Cl. H04N 5/445; H04N 5/91

(52) U.S. Cl. 725/46; 386/83

(57) ABSTRACT

A recording device comprising, information receiving unit receiving guide information of a program, operation receiving unit receiving information about a user's utilizing operation, recommendation level calculating unit obtaining a user's utilizing tendency based on a history of received information on the user's utilizing operation, and calculating a suitability level, as a program recommendation level, of the program guide information to the utilizing tendency, reserving unit automatically reserving recording of the program in accordance with the recommendation level, reservation management unit giving permission or non-permission of the reservation at predetermined timing, and recording unit recording the program based on the permitted reservation.

### CROSS-REFERENCE TO RELATED APPLICATIONS

This application is based upon and claims the benefit of priority of the prior Japanese Patent Application No. 2007-317118, filed on Dec. 7, 2007, the entire contents of which are incorporated herein by reference.

### FIELD

The embodiments discussed herein are directed to record of broadcasting program.

### BACKGROUND

Over the recent years, with an advancement of a television technology, functions for more facilitating viewing and recording TV (program) have been developed. In particular, a TV recording device using a large-capacity storage device such as a HD (hard disk) is capable of setting a recording reservation offhand by use of an electronic program guide (EPG). Thus, the technology capable of readily recording (the program) on the large-capacity storage medium leads to a large change in a TV viewing style of users.

For example, such a style is proposed that the TV recording device determines a user's preference based on a user's TV operation history, and automatically records the TV program suited to the preference, and the user views, if any, a favorite program in the auto-recorded programs.

In the case of performing the auto recording, even if there is an allowance in the storage capacity, the number of simultaneously-receivable programs is limited depending on the number of tuners, and it is therefore desirable that the program suited to the user's preference is highly accurately specified and recorded.

The user's preference does not, however, remain unchanged but changes with a passage of time, and hence, even if suited to the user's preference when making the recording reservation, there is a possibility of being unsuited to the user's preference when executing the recording.

### SUMMARY

According to an aspect of the invention, a recording device includes:

information receiving means receiving guide information of a program;

operation receiving means receiving information about a user's utilizing operation;

recommendation level calculating means obtaining a user's utilizing tendency based on a history of received information on the user's utilizing operation, and calculating a suitability level, as a program recommendation level, of the program guide information to the utilizing tendency;

reserving means automatically reserving recording of the program in accordance with the recommendation level;

reservation management means giving permission or non-permission of the reservation at predetermined timing; and

recording means recording the program based on the permitted reservation.

Additional objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a schematic view of a system using an auto recording device (recording device) in a first embodiment.

FIG. 2 is a schematic block diagram of the auto recording device.

FIG. 3 is an explanatory diagram of items contained in information (recording reservation information) organizing a reservation list.

FIG. 4 is a function block diagram of the auto recording device.

FIG. 5 is an explanatory diagram of an auto recording method executed by the auto recording device according to a recording program.

FIG. 6 is an explanatory diagram of the auto recording method executed by the auto recording device according to the recording program.

FIG. 7 is an explanatory diagram showing a list of extracted recommended programs and a reservation list to which the recommended programs are added.

FIG. 8 is a flowchart of a process of calculating a weight of a word & phrase (term) contained in guide information.

FIG. 9 is a flowchart showing how preference information is generated by use of an index.

FIG. 10 is a flowchart of a process of obtaining a program recommendation level for performing auto recording.

FIG. 11 is an explanatory diagram of the auto recording method in a second embodiment.

FIG. 12 is an explanatory diagram showing a recommended program list of the last time and a new recommended program list.

### DESCRIPTION OF EMBODIMENTS

Preferred embodiments of the present invention will be explained with reference to accompanying drawings.

For instance, the embodiment will exemplify an example of using a TV-function built-in information processing device (computer) as a recording device, however, the recording device is defined as a dedicated device such as a so-called hard disk recorder and a TV receiver incorporating a program recording function, and has no difference there between in terms of operation.

Moreover, the discussion will be made by exemplifying a history of recording operations by way of a content of the operations for obtaining a user's preference, however, a category of this operation may, without being limited to the recording operation, embrace the operations related to the user's preference such as viewing (a program), editing an already-recorded program and a movement to a DVD.

Further, the embodiment will be described by exemplifying a TV program as the program, however, the program may include, without being limited to the TV program, programs such as radio programs if capable of receiving guide information.

### First Embodiment

### 1. Device Configuration

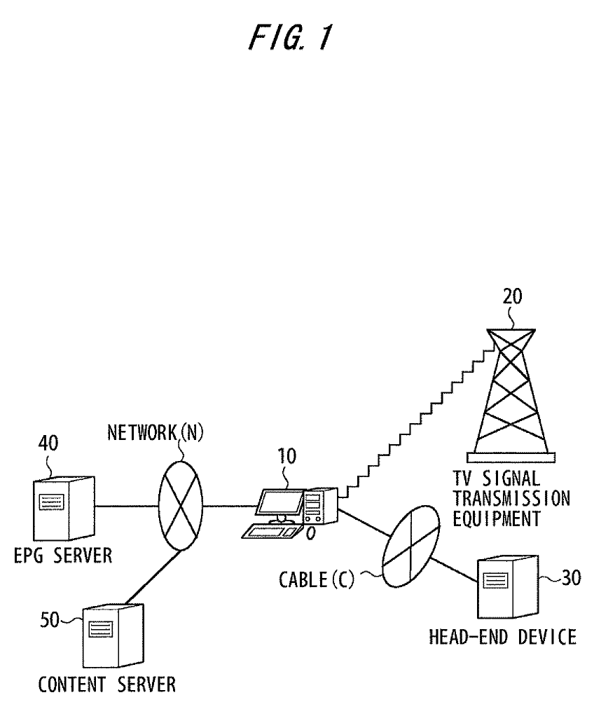

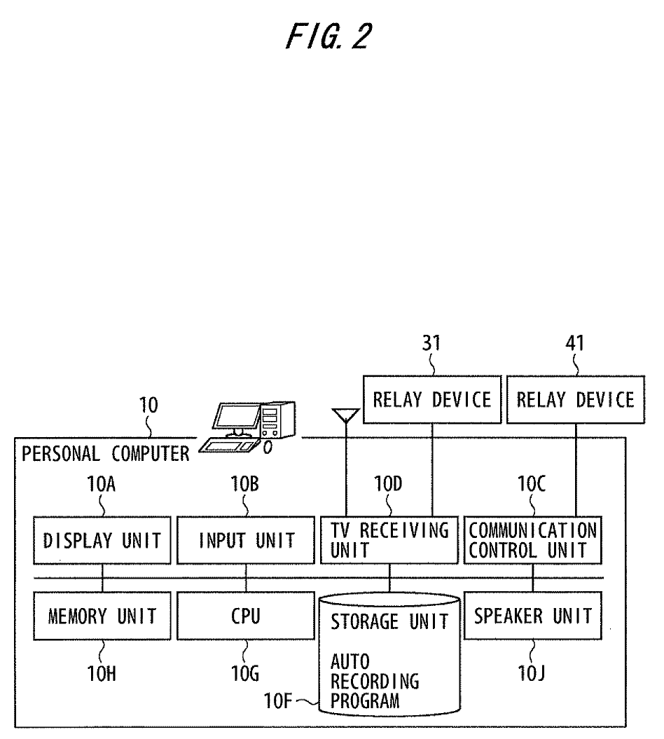

FIG. 1 is a schematic view of a system using an auto recording device (recording device) in the first embodiment, and FIG. 2 is a schematic block diagram of the auto recording device.

The auto recording device 10 receives and records a program broadcasted from a broadcasting station. A method of broadcasting the program may be, without being limited to the broadcasting as carried on radio waves, the broadcasting via a cable and the Internet. For example, as shown in FIG. 1, in the case of the broadcasting via the radio waves, the auto recording device 10 receives broadcasting radio waves transmitted from a television signal transmitter 20 of a television station directly or via a satellite etc. Further, in the case of a cable TV, the auto recording device 10 receives broadcasting signals transmitted from a head-end device 30 of a cable TV station via a cable C. Moreover, in the case of distributing a moving picture on the network such as the Internet, i.e., a so-called Internet TV, the auto recording device 10 receives data distributed from a content server 50 via the network.

Further, each broadcasting station transmits guide information (electronic program guide (EPG)) in the same way as broadcasting the program. The EPG is information for introducing the broadcasting schedule programs, and contains such items of information as broadcasting time, titles, captions and performers of the programs. Still further, the EPG is distributed from an EPG server 40 via the network.

The auto recording device 10 includes, as shown in FIG. 2, a CPU (Central Processing Unit) 10G, and a memory unit 10H, a display unit 10A, an input unit 10B, a communication control unit 10C, a TV receiving unit (TV tuner) 10D, a storage unit 10F, a loud speaker 10J, etc, which are connected via a bus to the CPU 10G.

The storage unit 10F is a large-capacity storage device such as a hard disk and is stored with an operating system (OS), application software (an auto recording program, a TV view program, etc) and program data.

The input unit (operation receiving means) 10B, to which operating means such as a keyboard, a pointing device and a remote controller are connected, receives information about operating (operation for utilizing) the operation means in order for the user to utilize the auto recording device, and inputs the information to the bus-side.

The TV tuner 10D receives the broadcasting waves from the TV station via the antenna 9, then encodes the received signals into program data in a predetermined format enabling the data to be processed by the CPU 10G and a graphic chip (unillustrated), and inputs the encoded data to the bus-side. Moreover, the TV tuner 10D receives the broadcasting signals transmitted from the head-end device 30 of the cable TV station via a relay device (e.g., a set-top box), then encodes the signals into the program data, and inputs the encoded data to the bus-side.

The communication control unit 10C controls communications with other computers via the network. For example, the communication control unit 10C, which connects to the content server 50 and the EPO server 40, receives and inputs the program data and the guide information (EPG) to the bus-side. In the first embodiment, the TV tuner 10D and the communication control unit 10C function as information receiving means.

The CPU (arithmetic processing unit) 10G properly reads the OS and application programs from the storage unit 10F, then executes the OS and the programs, and arithmetically processes the information acquired from the input unit 10B and the communication control unit 10C via the bus, thereby functioning also as a recommendation level calculating module 11A, a reservation module 11B, a reservation management module 11C, a recording module 11D (recording means) and a display control module 11E.

The recommendation level calculating module 11A obtains a user's utilizing tendency (preference information) based on a history of utilizing operation information received from the input unit 103, and calculates a suitability level of the guide information of the program to the utilizing tendency, as a recommendation level of the program.

The reservation module 11B automatically reserves (which will hereinafter be referred to also as an automatic reservation) a record of the programs, corresponding to the recommendation level. For example, the information of the program of which the recommendation level obtained by the recommendation level calculating module 11A exceeds a threshold value, is added to a list of reservations (reservation list) stored in the storage unit 10F.

Further, the reservation module 11B reserves the record of the programs by the user's utilizing operation (reserving operation) (which will hereinafter be termed a manual reservation). Namely, the user selects the program to be recorded from a program table of the EPG or inputs a recording channel and broadcasting time by operating the operating means such as the remote controller, whereby the reservation module adds the program information to the reservation list.

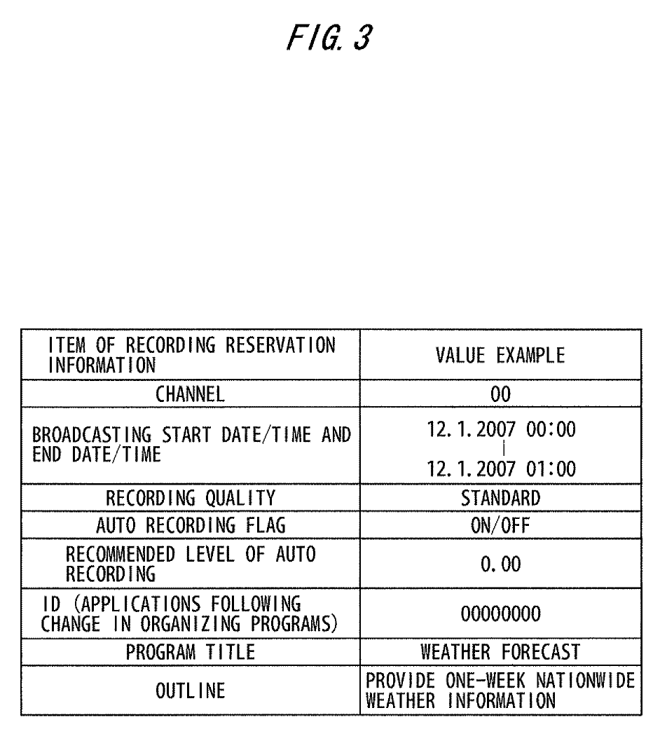

FIG. 3 is an explanatory diagram of items contained in the formation (recording reservation information) that organizes the reservation list.

In the first embodiment, the reservation information of each program contains at least the program broadcasting channel, the broadcasting time (starting date/time and ending date/time), the auto recording flag, and the recommendation level. Further, the reservation information may properly contain such items of information as a recording quality, a program ID, a program title, a caption and performers.

The auto recording flag is set ON in the case of the automatic reservation and set OFF in the case of the manual reservation.

The reservation management module 11C permits or do not permit the reservation at predetermined timing. To be specific, as will be described later on, the information of the program satisfying a predetermined condition, i.e., the information of the permitted program is added to the reservation list, while the program satisfying none of the condition is not permitted and is deleted from the reservation list.

The recording module 11D stores, based on the reservation list, the program in the storage unit 10F, i.e., records the program on the basis of the permitted reservation. Further, the recording module 11D stores an on-broadcasting program in the storage unit 10F in accordance with the user's recording operation. In the case of recording in accordance with the recording operation and in the case of recording in accordance with the manual reservation, the recording module (history registering module) 11D stores (registers) a history of the recording operation as a user's utilizing history in the storage unit 10F.

The display control module 11E reads, in the recorded programs, the program of which playback is instructed by the user's utilizing operation from the storage unit 10F, then replays this program, displays the moving picture on the display unit 10A, and outputs sounds (voices) from the loud speaker 10J.

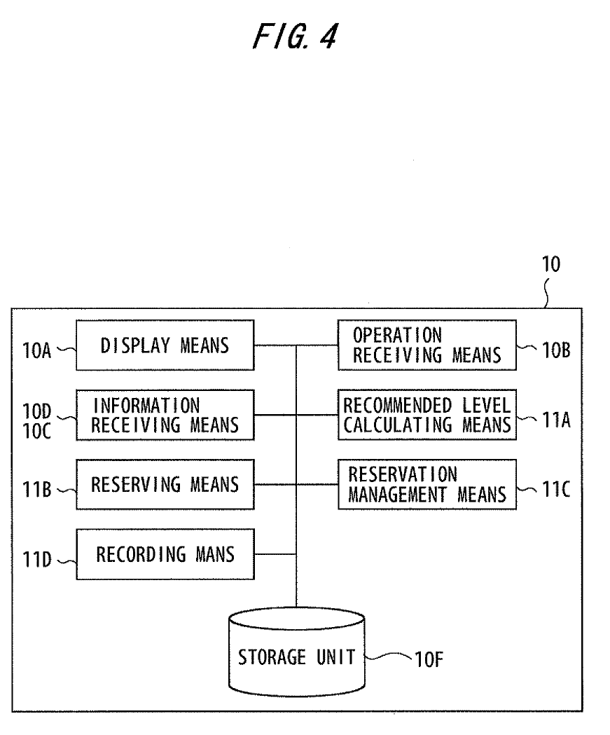

FIG. 4 is a function block diagram of the auto recording device 10. The auto recording device 10 in the first embodiment realizes softwarewise the functions of the modules 11A-1E by the multi-purpose computer executing the arithmetic processes based on the programs, and may also be an electronic apparatus in which the functions of the respective modules 11A-11E are realized by dedicatedly-designed electronic circuits (hardware).

### 2. Auto Recording Method

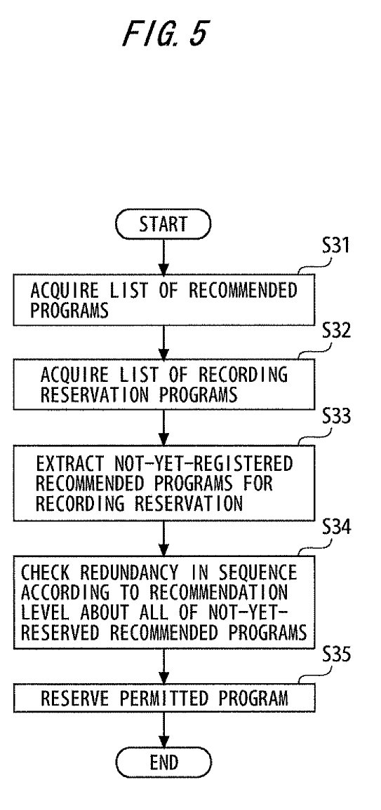

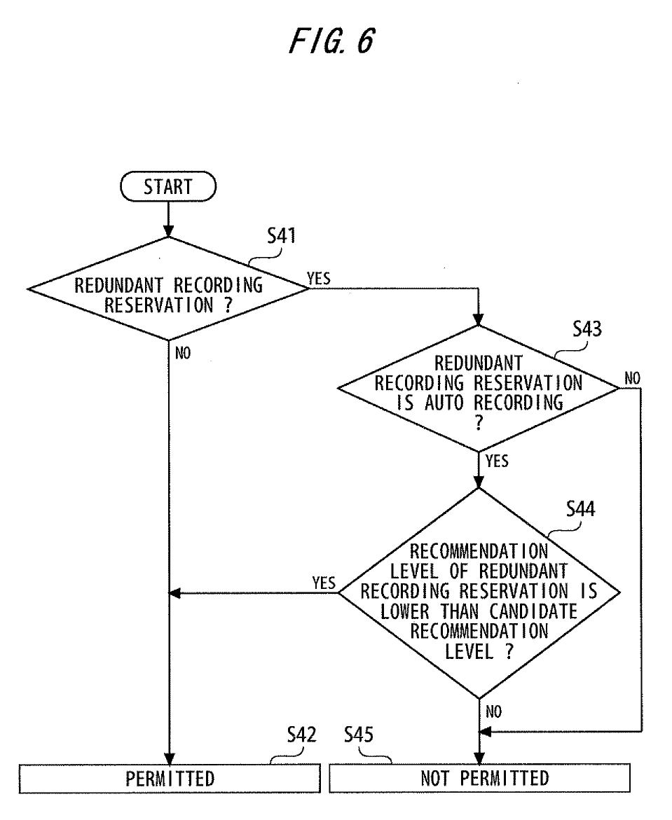

FIGS. 5 and 6 are explanatory flowcharts of an auto recording method executed by the auto recording device in accordance with a recording (videotaping) program (corresponding a recording program).

To start with, the recommendation level calculating module 11A acquires the guide information via the communication control unit 10C or the TV tuner 10D, obtains the recommendation level of each of the programs contained in the guide information, and extracts the information of the programs of which the recommendation levels each exceed the predetermined threshold value as a list of the recommended programs (step 31, which will hereinafter be abbreviated such as S31).

The reservation module 11B reads and acquires the reservation list from the storage unit 10F (S32), and extracts not-yet-reserved programs in comparison with the list of recommended programs (S33).

The reservation management module 11C determines about duplications between the not-yet-reserved programs extracted by the reservation module and the (reserved programs in) the reservation list, then distinguishes between the auto reservation and the manual reservation (which will hereinafter be termed reservation types) with respect to the duplicated programs, and determines the permission or non-permission corresponding to the recommendation level (S34).

The reservation module 11B adds the information of the permitted program to the reservation list, and makes the reservation (S35).

In the case of determining the permission or non-permission in step 4, the reservation management module 11C, as shown in FIG. 6, at first compares the not-yet-reserved programs with the already-reserved programs, and determines whether the broadcasting time thereof is overlapped or not (S41).

Herein, the reservation management module 11C permits the non-duplicated programs (S42) and, with respect to the duplicated programs, determines by referring to the reservation list whether the already-reserved programs are categorized into the auto recording or not (S43).

If the already-reserved program is categorized into the manual reservation, the auto recording program is not permitted in order to give the priority to the reservation by the user (S44). Further, if the duplicated program in the reservation list is categorized into the auto reservation, the recommendation level of the not-yet-reserved program is compared with the recommendation level of the already-reserved program (S45), and the program having the higher recommendation level is permitted (S42), while the program having the lower recommendation level is not permitted (S44).

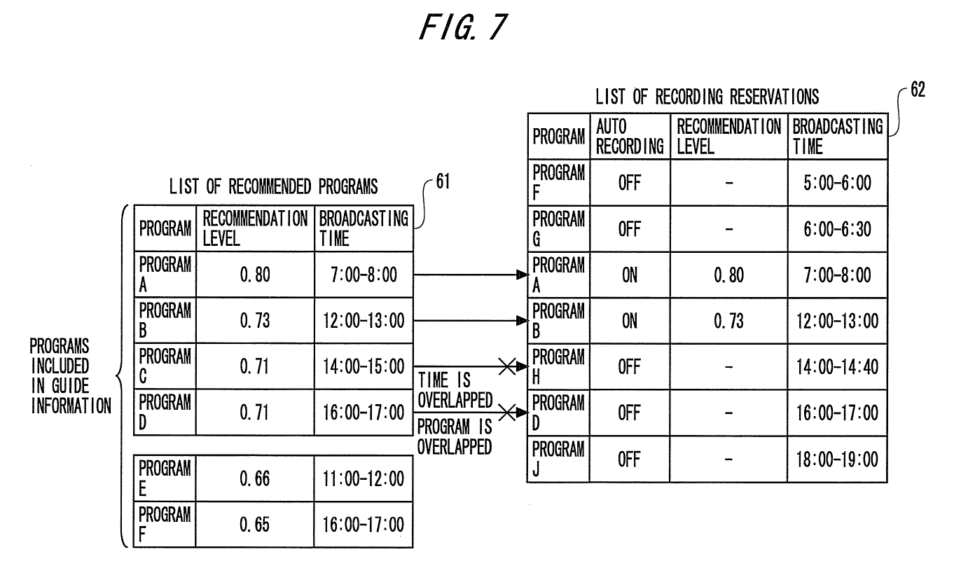

FIG. 7 is an explanatory diagram showing the list of the extracted recommended programs and the reservation list to which the recommended programs are added.

FIG. 7 shows that in programs A-F contained in the guide information, the programs A-D (whose recommendation levels are) over a threshold value 0.70 are set as the recommended programs, and the recommendation level calculating module 11A acquires a list 61 of the recommended programs in step 31. Then, the programs A-C unregistered in a reservation list 62 in the recommended program list 61 are extracted and added to the reservation list 62. At this time, the program C, of which the broadcasting time is overlapped with the program H reserved by the user, is therefore excluded, and only the programs A, B are added.

Thus, the duplication with the reservation list is determined when making the reservation, and the reservation list is updated, thereby enabling the program suited to the user's preference to be automatically recorded with high accuracy.

Next, a process of obtaining the recommendation level by extracting the user's preference will be described.

To begin with, the recommendation level calculating module 11A, for obtaining the user's utilizing tendency, reads the history of the user's utilizing operation from the storage unit 10F. Especially in the first embodiment, the storage unit 10F is stored with the history of user's recording-related operations (recording operations) such as an operation of reserving the recording of the program, an operation of recording the on-broadcasting program and an operation of canceling the reservation, and this recording history is read therefore.

Based on the utilizing history (recording history), the guide information of the utilized programs is acquired, and the user's preference is obtained from word & phrase as keywords contained in the guide information.

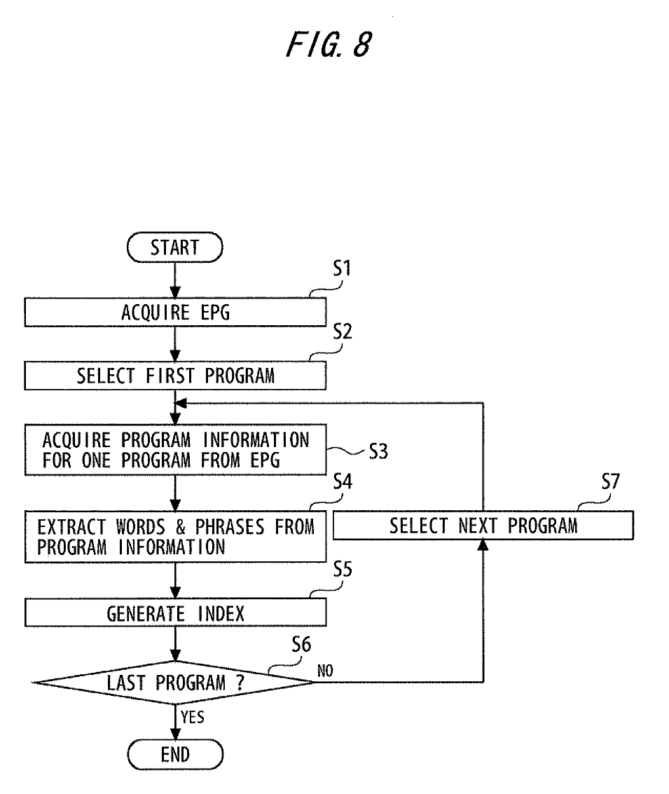

FIG. 8 is a flowchart for calculating a weight (index) of the word & phrase contained in the guide information of the recorded program and the recording-reserved program in order to extract the user's preference.

In FIG. 8, the recommendation level calculating module 11A at first acquires the EPG (guide information) of the programs recorded within a predetermined period (e.g., one month in the past) on the basis of the recording history (S1). In the first embodiment, when reserving the recording of the program and when recording the on-broadcasting program, the recording module stores the guide information of the respective programs in the storage unit 10F and reads the guide information from the storage unit 10F. Incidentally, an available scheme is that only program specifying information such as the program ID and the broadcasting time is recorded as the recording history, and the recommendation level calculating module 11A acquires the guide information of the program specified by the program specifying information from the EPG server 40 when calculating the preference.

Next, the recommendation level calculating module 11A selects the first program from the EPG (S2), and extracts the program information for one program (S3). The processing is targeted at all categories of information on condition that the program information is a text explaining a content of the program such as the program title, the caption, the performers and a genre.

Then, the word & phrase are extracted from the program information (S4). The extraction of the word & phrase can involve using a morphological analysis, however, without being limited to this morphological analysis, the word & phrase extraction processing technique is not particularly restricted if capable of extracting the word & phrase.

Subsequently, the index is generated from the extracted word & phrase (S5).

The index generating technique can involve utilizing [TF×1/DF]. TF (Term Frequency) represents a frequency at which a specified term (keyword) appears in a certain program. Further, DF (Document Frequency) represents the number of programs (a program count) containing the specified term (keyword) in all of the programs.

Then, a statistic quantity of the term (word & phrase) is [TF×1/DF], and this is the weight of the word & phrase.

In the case of generating the index by this technique, the index is generated in a vector space of i×j, where i is the program count, and j is the category of the word & phrase (term) extracted from the programs. A weight of each of the elements of the index is designated by W, and a value given by the [TF×1/DF] is used.

Subsequent to the generation of the index, it is determined whether the program is the last program or not (S6), then the next program is selected (S7) if not the last program (N in S6), and the operation loops back to the process in step S3. Then, the processes in steps S3-S6 (or S3-S7) are repeated. The index of the recorded program is thereby generated.

Then, if determined to be the last program in the determination in step S6 (Y in S6), the processing comes to an end.

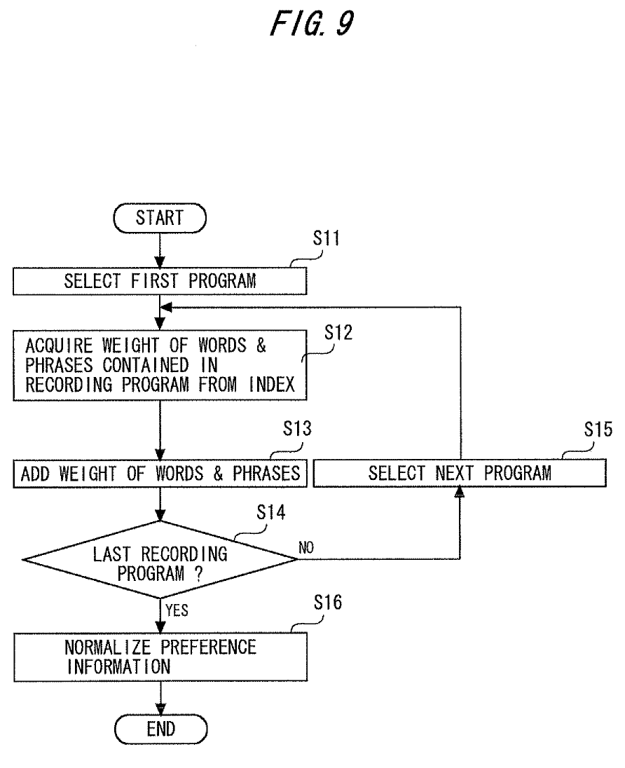

FIG. 9 is a flowchart showing how the preference information is generated by use of the index.

In FIG. 9, at first, the first recording program is selected from the recording history (S11). Subsequently, the weight of the word & phrase contained in the selected recording program is obtained from the index generated by the processes shown in FIG. 8 (S12).

Then, in this process, if the same word & phrase repeatedly appears, the weight is added each time (S13).

Subsequently, it is determined whether the program is the last recording program or not (S14), then the next recording program is selected (S15) if not the last recording program (N in S14), and the operation loops back to the process in step S12.

Then, the processes in steps S12-S14 (or S12-S15) are repeated. The preference information, to which the weights of the respective words & phrases contained in the guide information of the recording program are individually added, is thereby generated.

Subsequently, if determined to be the last recording program in the determination in step S14 (Y in S14), the generated preference information is normalized for the process of obtaining the recommendation level which will be explained later on (S16), and the processing is terminated.

The normalized preference information serves as a benchmark for obtaining the recommendation level of the program. Note that the normalization of the preference information is exemplified such as cosine normalization and pivot normalization, however, any types of methods, if each defined as the normalizing technique, may also be employed.

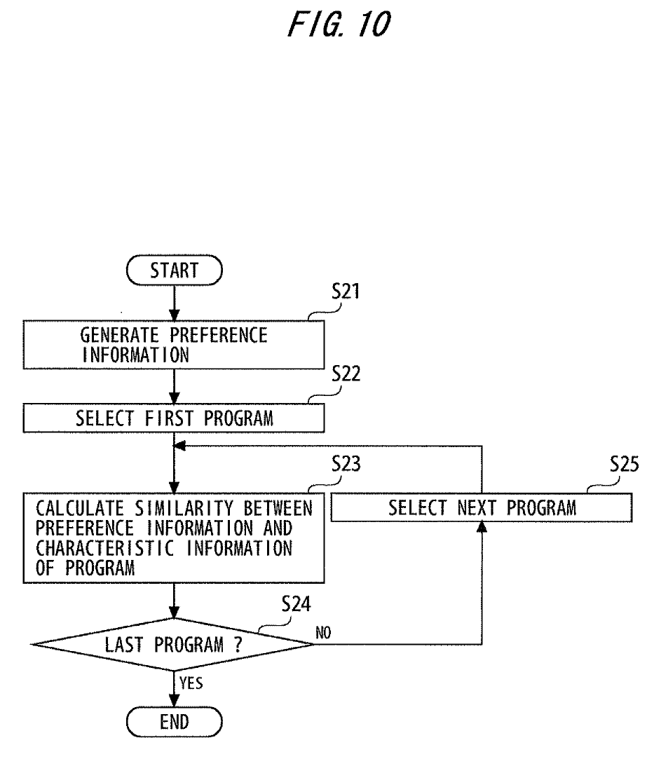

FIG. 10 is a flowchart showing the process of obtaining the recommendation level of the program in order to perform the auto recording.

In FIG. 10, the recommendation level calculating module 11A acquires the guide information from the present information onward via the communication control unit 10C and the TV tuner 10D, and calculates and normalizes information to which the weight of each of the words & phrases contained in the guide information of the respective programs is individually added (which will hereinafter be referred to as characteristic information and is equivalent to the preference information in FIG. 9) by the same method as by the processes shown in FIG. 9 (S21).

Next, the first program is selected from the EPG (S22), and a level of suitability (similarity) of the characteristic information of the selected program to the user's preference information is obtained and set as the recommendation level of the program (step S23).

The calculation of the recommendation level can be realized by calculating, e.g., a product of the weight of the word & phrase contained in common in a preference query and each search target program, and calculating a sum of the products within the program.

In this case, the recommendation level of the program gets higher as the characteristic information of the program is more similar to the user's preference information, i.e., as the program is more suited to the user's preference, and hence the program of which the recommendation level exceeds the predetermined threshold value is set as the recommended program.

Thereafter, it is determined whether the program is the last program or not (step S24), then the next program is selected (step S25) if not the last program (N in S24), the operation loops back to the process in step S23, and the processes in step S23-S24 (or S23-S25) are repeated.

Then, if determined to be the last program in the determination in step S24 (Y in S24), the processing is finished. The list of the recommended programs each exceeding the threshold value can be generated out of the guide information from the present onward.

As described above, the user's preference information is based on the program recorded or reserved by the user, and therefore it follows that the preference information changes if the user newly performs the reserving and recording operations or if conducting the operation for canceling the reservation.

Such being the case, each time the operation receiving module receives the information of the user's utilizing operation, the recommendation level calculating module calculates the recommendation level, and the user's preference information is obtained on demand. With this scheme, the auto recording suited to the user's preference can be done following the change of the user's preference.

### Second Embodiment

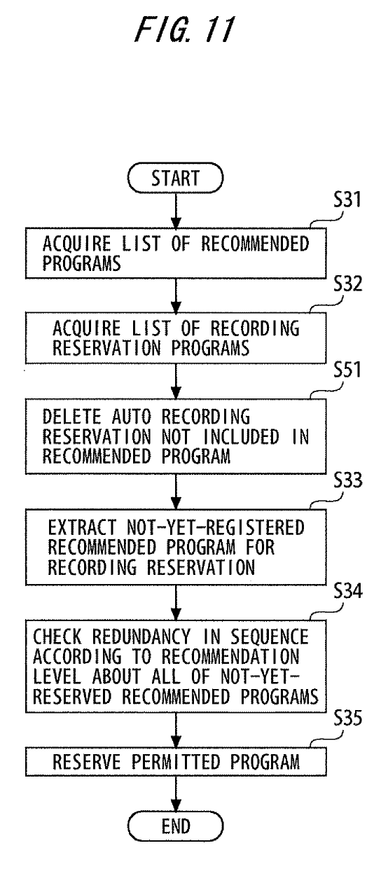

FIG. 11 is an explanatory diagram of the auto recording method in a second embodiment. The second embodiment is different from the first embodiment discussed above in terms of deleting the auto reservation not included in the recommended program list from the reservation list, but other configurations are the same. Hence, the same components are marked with the same numerals and symbols, and their repetitive explanations are omitted.

In FIG. 11, the recommendation level calculating module 11A acquires the same recommended program list and the same reservation list as those described above (S31, S32), and deletes the information of the program not included in the recommended program list in the auto-reserved programs included in the reservation list (S51).

Then, the not-yet-registered recommended program is extracted for the recording reservation (S33), the duplication checking process shown in FIG. 6 is executed about this not-yet-registered recommended program (S34), and a non-duplicated but permitted program is reserved (S35).

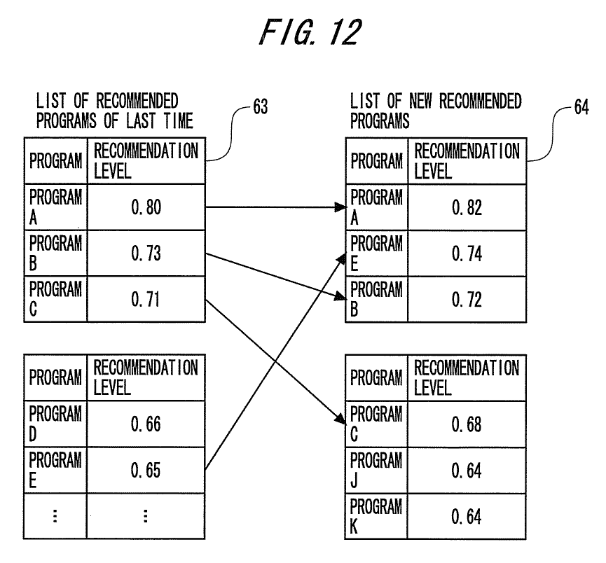

FIG. 12 is an explanatory diagram showing how the recommended program is updated.

In FIG. 12, among the programs A-E contained in the guide information, the programs A-C each exceeding the threshold value 0.70 last time is grouped as a recommended program list 63, and the programs A, E, B each exceeding the threshold value 0.70 is this time is grouped as a recommended program list 64.

In the recommended program list 63 of the last time, the program C exceeds the threshold value and becomes the recommended program, however, as the user's preference changes, in the new recommended program list 64, the program C is excluded, while the program E is added.

Accordingly, if the auto recording method in FIG. 11 is executed based on this new recommended program list 64, the auto-reserved program C of the last time is deleted from the reservation list, while the new program E is added to the reservation list.

Thus, according to the second embodiment, even the already-reserved program, if not suited to the user's preference due to the change of the user's preference, can be deleted, and the auto reservation suited to the user's preference can be done with the high accuracy.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention(s) has(have) been described in detail, it should be understood that the various changes, substitutions, and alterations could be made hereto without departing from the spirit and scope of the invention.

Further, the auto recording program may be recorded on a readable-by-computer recording medium. The computer is made to read and execute the program on the recording medium, whereby the function thereof can be provided.

Herein, the readable-by-computer recording medium connotes a recording medium capable of storing information such as data and programs electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc are given as the recording mediums fixed within the computer.

1. A recording device comprising:
information receiving unit receiving guide information of a program;
operation receiving unit receiving information about a user's utilizing operation;
recommendation level calculating unit obtaining a user's utilizing tendency based on a history of received information on the user's utilizing operation, and calculating a suitability level, as a program recommendation level, of the program guide information to the utilizing tendency;
reserving unit automatically reserving recording of the program in accordance with the recommendation level;
reservation management unit giving permission or non-permission of the reservation at predetermined timing; and
recording unit recording the program based on the permitted reservation.

2. The recording device according to claim 1, wherein if the reservation made by the user is overlapped with the automatic reservation, the reservation management unit does not permit the automatic reservation.

3. The recording device according to claim 1, wherein if the automatic reservation is overlapped, the reservation management unit does not permit the reservation exhibiting a lower recommendation level.

4. The recording device according to claim 1, wherein when receiving the information on the user's utilizing operation, the recommendation level calculating unit newly calculates the program recommendation level, and
if the new recommendation level exceeds the predetermined threshold value, the reserving unit reserves the recording of the program.

5. The recording device according to claim 1, wherein when receiving the information on the user's utilizing operation, the recommendation level calculating unit newly calculates the program recommendation level, and
if a recommendation level of an in-reservation program is lower than the predetermined threshold value, the management unit does not permit the reservation of the program.

6. The recording device according to claim 1, wherein when receiving the program guide information, the recommendation level calculating unit calculates the program recommendation level, and
if the newly received program recommendation level exceeds the predetermined threshold value, the reserving unit reserves the recording of the program.

7. An auto recording method executed by a recording device, the auto recording method comprising:
receiving guide information of a program;
receiving information about a user's utilizing operation;
obtaining a user's utilizing tendency based on a history of received information on the user's utilizing operation, and calculating a suitability level, as a program recommendation level, of the program guide information to the utilizing tendency;
automatically reserving recording of the program in accordance with the recommendation level:
giving permission or non-permission of the reservation at predetermined timing; and
recording the program based on the permitted reservation.

8. The auto recording method according to claim 7, wherein if the reservation made by the user is overlapped with the automatic reservation, the automatic reservation is not permitted.

9. The auto recording method according to claim 7, wherein if the automatic reservation is overlapped, the reservation exhibiting a lower recommendation level is not permitted.

10. The auto recording method according to claim 7, wherein when receiving the information on the user's utilizing operation, the program recommendation level is newly calculated, and
if the new recommendation level exceeds the predetermined threshold value, the recording of the program is reserved.

11. The auto recording method according to claim 7, wherein when receiving the information on the user's utilizing operation, the program recommendation level is newly calculated, and
if a recommendation level of an in-reservation program is lower than the predetermined threshold value, the reservation of the program is not permitted.

12. The auto recording method according to claim 7, wherein when receiving the program guide information, the program recommendation level is calculated, and if the newly received program recommendation level exceeds the predetermined threshold value, the recording of the program is reserved.

13. A storage medium readable by a computer, tangible embodying a program of instructions executable by the computer to perform method steps comprising:
receiving guide information of a program;
receiving information about a user's utilizing operation;
obtaining a user's utilizing tendency based on a history of received information on the user's utilizing operation, and calculating a suitability level, as a program recommendation level, of the program guide information to the utilizing tendency;
automatically reserving recording of the program in accordance with the recommendation level:
giving permission or non-permission of the reservation at predetermined timing; and
recording the program based on the permitted reservation.

14. The storage medium according to claim 13, wherein if the reservation made by the user is overlapped with the automatic reservation, the automatic reservation is not permitted.

15. The storage medium according to claim 13, wherein if the automatic reservation is overlapped, the reservation exhibiting a lower recommendation level is not permitted.

16. The storage medium according to claim 13, wherein when receiving the information on the user's utilizing operation, the program recommendation level is newly calculated, and
if the new recommendation level exceeds the predetermined threshold value, the recording of the program is reserved.

17. The storage medium according to claim 13, wherein when receiving the information on the user's utilizing operation, the program recommendation level is newly calculated, and
if a recommendation level of an in-reservation program is lower than the predetermined threshold value, the reservation of the program is not permitted.

18. The storage medium according to claim 13, wherein when receiving the program guide information, the program recommendation level is calculated, and
if the newly received program recommendation level exceeds the predetermined threshold value, the recording of the program is reserved.
